(19) United States
(12) Patent Application Publication
(10) Pub. No.: US 2008/0085171 A1
(43) Pub. Date: Apr. 10, 2008

(54) Ratchet fit fastener

(76) Inventor: Grant Perry Brown, Red Deer (CA)

Correspondence Address: BENNETT JONES;C/O MS ROSEANN CALDWELL, 4500 BANKERS HALL EAST, 855 - 2ND STREET, SW, CALGARY, AB, T2P 4K7, US

(21) Appl. No.: 11/543,209

(22) Filed: Oct. 5, 2006

(51) Int. Cl. F16B 23/00

(52) U.S. Cl. 411/403

(57) ABSTRACT

A ratchet mounting fastener includes a rigid body having a socket drive receiving cavity formed in a first end for receiving a male socket drive shaft into snug mating engagement and releasable locking means to releasably lock the fastener onto the drive shaft, and having a threaded portion on an opposite second end for threaded mating engagement of the threaded portion with a threaded second fastener, and wherein the cavity and the threaded portion are oppositely disposed for mounting of the drive shaft to the cavity and mounting of the second fastener to the threaded portion from opposed facing opposite directions.

### FIELD OF THE INVENTION

This invention relates to the field of threaded fasteners and in particular to a ratchet fit fastener which provides a female threaded fastener for replacing the function of a threaded nut wherein the fastener has a female socket oppositely disposed from, and axially aligned with the threaded female fastener cavity.

### BACKGROUND OF THE INVENTION

In the prior art applicant is aware of U.S. Pat. No. 2,148,959 which issued to Pavlecka on Feb. 28, 1939, for an Internal Hexagonal Stop Nut and Method of Making Same. Pavlecka teaches a self locking nut and in particular an elastic stop nut having a polygonal socket so that the stop nut may be screwed onto and off of the screw member with which it cooperates. It is taught that the cross sectional sides of the polygonal socket allows a corresponding polygonal portion of a mandrel to be slidable into the socket. It is taught that the shoulders of the polygonal socket are engageable by a socket wrench.

What is neither taught nor suggested by Pavlecka, and which it is an object of the present invention to provide, is the adaptation of the socket end so as to be mountable directly to the square-headed stub drive shaft of a socket wrench or an extension member which is mountable so the socket wrench, the extension member having on its distal end a head for mating with a socket for driving a nut ordinarily but in the present invention for mating with an un-threaded end of a ratchet fit threaded fastener. Thus what is neither taught nor suggested, and which it is an object of the present invention to provide, is the direct mounting of the square-head of a stub drive shaft or extension member extending from the socket wrench directly into the socket end of a ratchet-fit threaded fastener, and in particular to include a female threaded fastener so as to replace the use of a nut. The square-headed drive shaft, whether the stub shaft or extension, is releasably positively locked into the socket end of the fastener itself to thereby provide for mounting of the fastener into threaded cooperation with a corresponding cooperating male fastener such as a male threaded fastener including a bolt, stud or the like. Because the female fastener according to the present invention is locked onto the drive axle of the socket wrench, the female fastener may be guided in its entry to the male fastener from awkward angles and through very tight clearances where a user otherwise could not reach so as to accurately position and place the fastener for threaded cooperation between the male and female fasteners without the likelihood, as in the existing prior art, that the female fastener for example would be dropped and thus have to be retrieved.

For example, in the prior art, it is quite common when working on automotive engines and in particular automotive engines used for racing, where space is at a premium in the engine compartment, that access must be had to for example the studs used for securing valve covers. This is just one example of where access is difficult so that even the most experienced mechanic will waste valuable time in trying to remotely place a female fastener such as a nut onto the free end of the stud and then rotating the nut so as to engage the stud without dropping the nut. If the nut is dropped it typically must be retrieved, and especially in racing and other engine environments such as jet engines, where foreign object damage to the engine is a constant threat and thus dropped and lost nuts must be rigorously guarded against.

In these sorts of applications, especially where foreign object damage may not be tolerated or where access tolerances are very tight so as to prevent manual access by a mechanic needing to install a fastener, it is imperative that the fastener be securely held on the free or distal end of a tool which securely holds the fastener in a known orientation for remote manipulation by the mechanic. Such a tool, such as in the present invention, allows the mechanic to, firstly, place the fastener threads in the proper orientation for engaging the corresponding threads on the corresponding opposed facing fastener, for example the free end of a stud, and, secondly, for then rotating the fastener on the tool so as to threadably engage the pair of corresponding fasteners one with the other. Thus, the mere sliding fit such as taught in the prior art including that Pavlecka, is insufficient without more so as to guarantee a positive lock of the fastener on the end of the fastener application tool such as the end of a socket wrench, thereby risking dropping the fastener.

### SUMMARY OF THE INVENTION

Thus in the present invention, applicant came to the realization that a positive locking, secure yet releasable drive mount existed already in common collections of tools; namely, a conventional socket wrench handle having a square-headed stub drive shaft protruding from the socket wrench head. Typically the square-headed stub drive shaft protruding from the head of the socket wrench has a spring-loaded ball mounted in at least one of the sides of the shaft. Each spring-loaded ball engages a corresponding detent in the female socket receiving cavity of a typical socket wrench attachment such as one of a series of different sizes of demountable sockets. Such conventional sockets have on one end a square socket receiving opening for receiving the socket wrench drive shaft whether the stub shaft or the end of an extension, and in their other end, a polygonal socket for receiving therein a nut so that rotation of the drive shaft by the socket wrench turns the nut on to the threaded end of the bolt or like male fastener. With regards to the use of extensions, it is well understood that one end of the extension mounts onto the stub drive shaft, and the other end of the extension is shaped as a replica of the square-headed stub drive shaft for mounting into the square shaft receiving receptacle in the socket.

The conventional use of a socket wrench and corresponding socket attachments, whether or not using an extension therebetween, results in a conventional nut being loosely held in sliding engagement within the polygonal socket receiving end of the socket attachment, which is not particularly useful in the applications to which the present invention is directed. For example, where through very tight clearances a nut has to be threaded onto a vertically aligned exposed threaded stud, the use of a conventional socket, whether or not on the end of an extension, means that at some point the socket is turned to the vertical thereby allowing the nut to slide and drop out of the polygonal opening in the lowest end of the socket attachment. This is illustrated in FIG. 1. This then results in the mechanic having to retrieve the nut which may require disassembly of components of, for example the motor.

In summary, the present invention may be characterized in one aspect as a ratchet mounting close-fit fastener including a rigid fastener body having opposite first and second ends and a substantially smoothly curved outer surface extending from the first end to the second end. The first end has a socket drive receiving cavity formed therein for receiving a male socket drive shaft into snug mating engagement along a longitudinal axis of the body. Releasable locking means in the cavity cooperate between the cavity and the drive shaft so as to releasably lock the fastener body onto the drive shaft. The second end is formed to include a threaded portion. The threaded portion is symmetric about the longitudinal axis for threaded mating engagement of the threaded portion with a corresponding matingly-threaded second fastener. The cavity and the threaded portion are oppositely disposed for mounting of the drive shaft to the cavity and mounting of the second fastener to the threaded portion from opposed facing opposite directions.

Advantageously, the outer surface does not include shoulders formed along the outer surface so as to be parallel with the longitudinal axis of the fastener body.

In one embodiment the threaded portion is a female threaded bore the cavity and the bore may be separated by a sealed barrier such as a rigid membrane between the cavity and the bore. A de-mountable cap may be provided for releasable mounting onto the first end of the fastener so as to seal an opening into the cavity. Alternatively, the threaded portion is a threaded male end having a threaded surface around its exterior surface. The outer surface may be substantially cylindrical.

The bore and the fastener body may be cylindrical. The bore has a diameter measured orthogonal to the axis and a length along the longitudinal axis. The length may be at least equal to the diameter. In a preferred embodiment the second end terminates in a planar surface substantially orthogonal to the longitudinal axis. In particular, the planar surface may be an annular surface extending circumferentially around an opening into the bore so as to provide a bearing surface around the opening.

A ratchet mounting close-fit fastener system according to the present invention may include first and second fastener elements, where each of the two elements has a rigid body having opposite first and second ends, and a substantially smoothly curved outer surface extending from the first end to the second end. Each of the elements has a first end having a socket drive receiving cavity formed therein for receiving a male socket drive shaft into snug mating engagement along a longitudinal axis of the body, and a releasable locking means cooperating between the cavity and the drive shaft so as to releasably lock the fastener onto the corresponding drive shaft. Each of the elements also has a second end, opposite its first end, formed to include a threaded portion. The threaded portion of each element is symmetric about the longitudinal axis for threaded mating engagement of the threaded portion of each the elements with each other. Again, the cavity and the threaded portion are oppositely disposed on each element for mounting of a drive shaft to the cavity and mounting of the elements to each other from opposed facing opposite directions.

The threaded portion of the first fastener element may be a female bore threaded end and the threaded portion of the second fastener element is a male threaded end sized to threadably mate into the female bore threaded end.

### BRIEF DESCRIPTION OF THE DRAWINGS

FIG. 1 is, in partially exploded perspective view, a prior art socket wrench, socket attachment, and nut for mounting onto an exposed vertical threaded stud.

FIG. 2 is, in partially exploded perspective view, a conventional socket wrench being mounted onto a female ratchet fit fastener according to the present invention for threaded mounting of the fastener onto an exposed threaded stud.

FIG. 3 is, in partially exploded view, the ratchet fit fastener of FIG. 2 being threadably mounted onto an exposed threaded stud by the use of a conventional socket wrench and extension.

FIG. 4 is, in side elevation view, the ratchet fit fastener of FIG. 2 with the drive shaft receiving cavity and threaded bore shown in dotted outline.

FIG. 5 is the fastener of FIG. 4 in perspective view.

FIG. 6 is, in plan view, the fastener of FIG. 4.

FIG. 7 is, in bottom view, a fastener according to the present invention and sized to accept a smaller socket wrench stub drive shaft.

FIG. 8 is, in bottom view, the fastener of FIG. 7 having a rigid membrane separating the threaded bore from the drive shaft receiving cavity.

FIG. 9 is, in perspective view, a cap for mounting into the drive shaft receiving cavity.

FIG. 10a is, in perspective view, a male threaded fastener according to one aspect of the present invention.

FIG. 10b is, in side elevation view, the fastener of FIG. 10a.

FIG. 10c is in plan view, the fastener of FIG. 10b.

### DETAILED DESCRIPTION OF EMBODIMENTS OF THE INVENTION

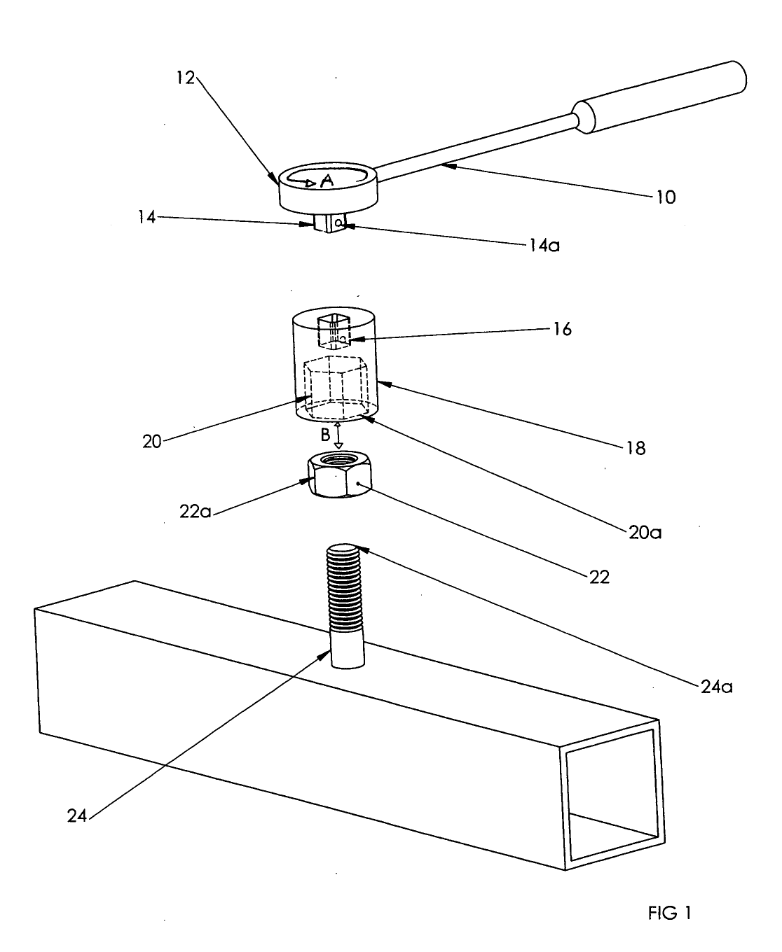

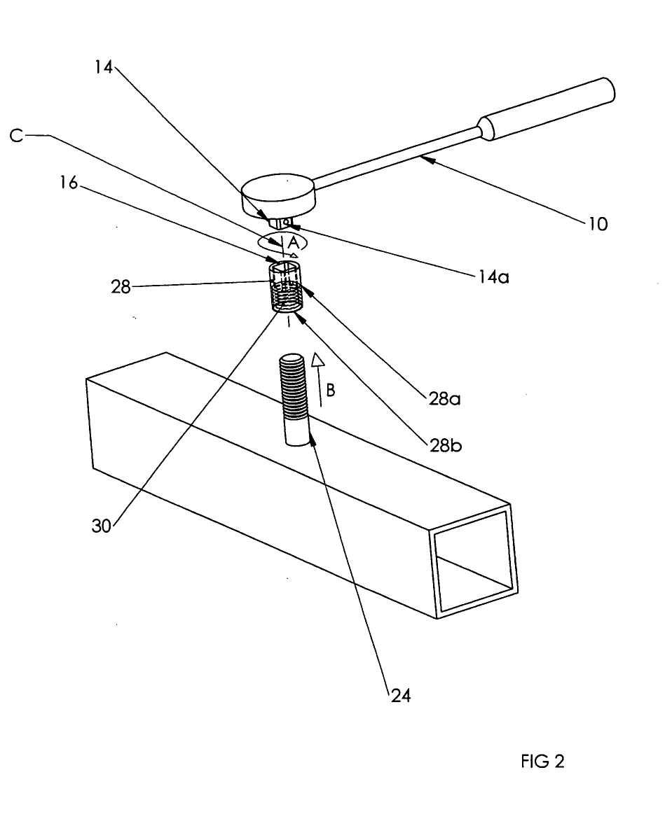

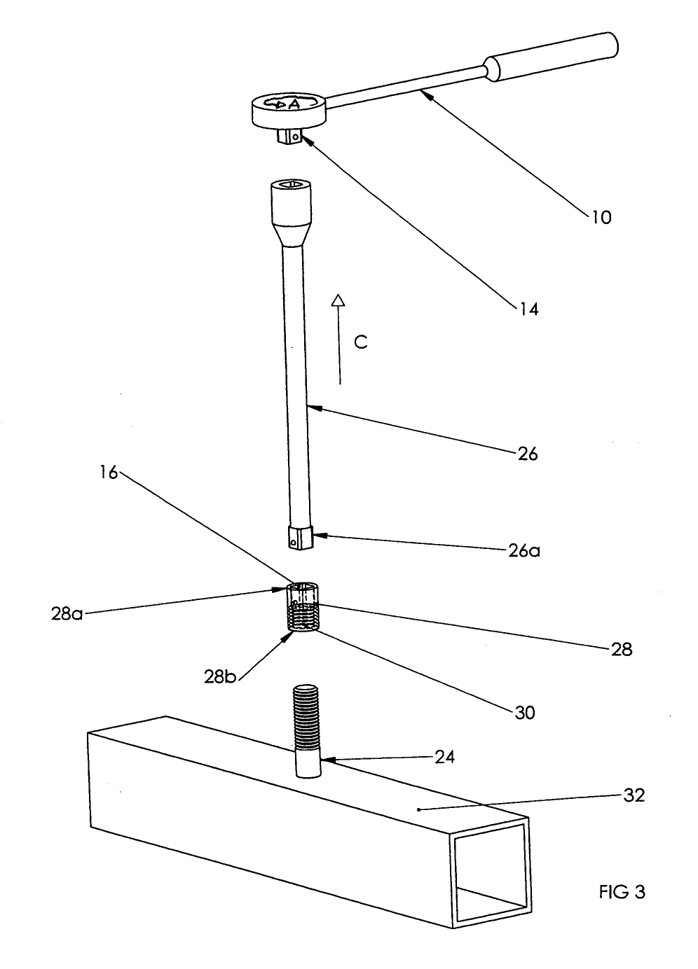

As may be seen in FIG. 1, a conventional socket wrench 10 includes a ratcheting head 12 driving a square-headed stub drive shaft 14 so as to rotate drive shaft 14 in direction A. Stub drive shaft 14 mounts into a correspondingly sized and correspondingly shaped shaft receiving socket 16 (shown in dotted outline in FIG. 1) in a conventional socket attachment 18. Socket attachment 18 has at it's opposite end a nut receiving socket 20 for receiving in relatively loose, sliding engagement therein a nut 22. The nut may be slid in direction B in to and out of nut receiving socket 20. Nut 22 engages against correspondingly shaped shoulders 20a lining socket 20. With nut 22 initially threaded onto the distal end 24a of bolt or stud 24, for example by hand tightening nut 22 onto stud 24, nut receiving socket 20 may then be slid over nut 22 and socket 10 rotated so as to rotate shaft 14 in direction A thereby correspondingly turning nut 22 in threaded engagement along stud 24. Again it is important to note that typically, if nut 22 has: not been mounted onto stud 24 before socket attachment 18 is fitted onto the nut, for example if nut 22 is merely slid into nut receiving socket 20, when socket attachment 18 is turned to the vertical so as to orient nut receiving socket downwardly, typically in applicant's experience, nut 22 will merely fall out of the socket attachment. It is thus difficult if not impossible to remotely manipulate the socket wrench and socket attachment so as to mount the nut onto the stud without the manual threading of the nut onto the stud first.

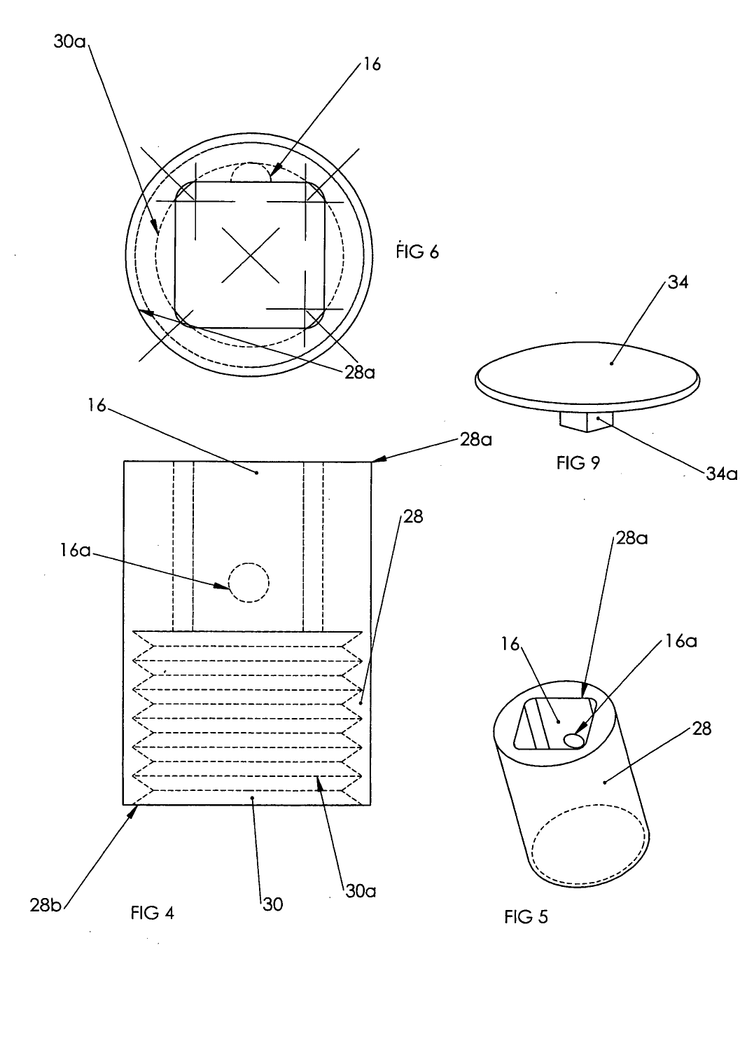

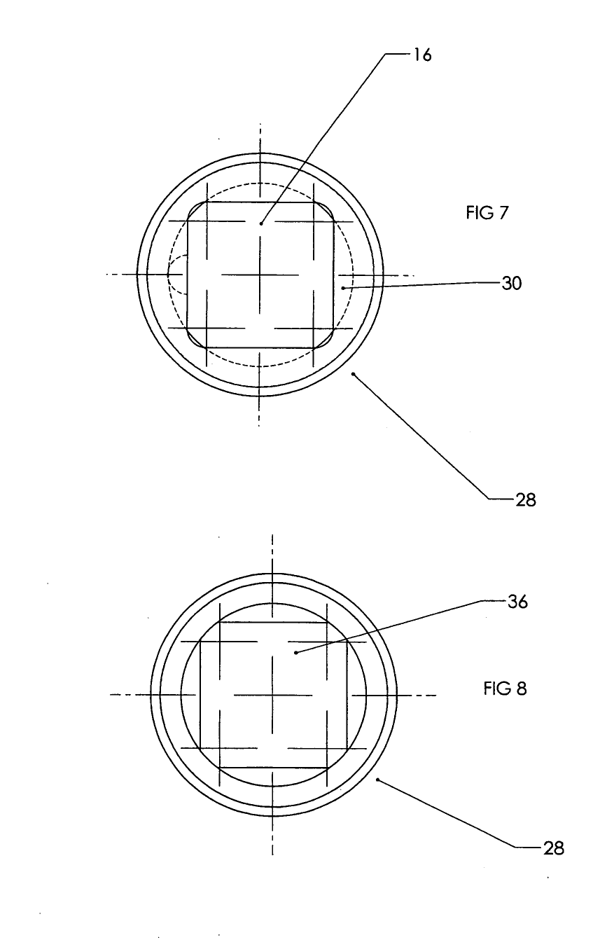

Thus in the present invention, the conventional socket attachment 18 whether or not used in conjunction with a conventional socket extension 26, is entirely replaced with a threaded fastener 28 according to the present invention such as a female threaded fastener 28. Female fastener 28 releasably lockably mounts, at its end 28a, onto stub drive shaft 14 or onto the corresponding square head of the driving end of an extension 26. Threaded fastener 28 may be pinched or otherwise stove in the sense of a stove nut to create a locking thread. The opposite end 28b of fastener 28 threadably mounts onto bolt or stud 24. Thus female threaded fastener 28 has a square-headed shaft receiving socket 16 for receiving therein stub drive shaft 14 or head 26a. Drive shaft 14 or head 26a is inserted into socket 16 so as to engage a spring-loaded ball 14a on shaft 14, or a corresponding ball on head 26a, with a corresponding detent 16a formed in one or more sidewalls (for example, all of the sidewalls) of shaft receiving socket 16. It is understood that detent 16a need not necessarily be round or spherical such as illustrated in dotted outline in FIG. 4, but may also be formed as an elongate groove or channel formed in the sidewall so long as, with shaft 14 or head 26a completely mounted into socket 16, spring-loaded ball 14a lodges resiliently into resiliently biased engagement with the detent, in whatever form, so as to resist drive shaft 14 or head 26a being removed from socket 16. Thus it is understood that if a socket extension 26 is employed so as to extend the reach between socket wrench 10 and fastener 28, then instead of drive shaft 14 engaging into shaft receiving socket 16 in fastener 28, that drive head 26a of extension 26, which it is understood to be formed as a replica of stub drive shaft 14 including a spring-loaded ball (not shown), will also fully mate into shaft receiving socket 16 to thereby lockably and releasably mate with fastener 28. Fastener 28 is thus held securely and typically will not be removed from shaft 14 or head 26a until threads 30a within threaded bore 30 are threadably mounted onto the corresponding threads of bolt or stud 24 by rotation of fastener 28 in direction A about its longitudinal axis C.

Socket wrench 10, including extension 26 if used, may then be removed by sharply pulling the socket wrench and extension in a direction away, and coaxial with, bolt or stud 24 for example in direction D. Thus with fastener 28 threadably mounted onto bolt or stud 24 for example so as to torque fastener 28 snugly down onto stud 24 so that the length of stud 24 extends a significant proportion of the length threaded bore 30 (by conventional rule of thumb, this distance being substantially equal to the diameter of the fastener), pulling sharply both the socket wrench, and extension if used, in direction D disengages the corresponding spring-loaded ball from detent 16a thereby allowing the removal of stub drive shaft 14, or the corresponding drive head 26a if an extension is used, from within socket 16 thereby leaving fastener 28 engaged onto bolt or stud 24.

It is understood that a conventional socket wrench 10 may be replaced by a modified socket wrench such as that which is the subject of U.S. Pat. No. 5,058,463 which issued to Wannop on Oct. 22, 1991 for a Ratchet Wrench With Dual-Rotating Constant Drive Handle. The use of the modified socket wrench of Wannop would also provide for the use of fasteners 28 in very hard to reach places with very tight or close tolerances where for example a straight-in mounting of the fastener in coaxial alignment with the stud is not possible because of obstructions, therefore requiring the entry of the socket wrench carrying fastener 28 from a different angle so as to mount fastener 28 onto stud 24 from an entry passageway which is orthogonal to the stud.

For use in extremely tight access spaces where the tolerances are such that a nut of a desired bearing surface area will not fit due to the protrusion of the upstanding shoulders 22a from the sides of the nut, the female fastener 28 according to the present invention will provide substantially the same bearing surface but will fit through the close tolerances due to the lack of the external shoulders 22a such as found on the exterior of a conventional nut. Were a conventional socket attachment 18 employed, then in order to fit the socket attachment 18 through the close tolerance, an even smaller nut, having what may be an insufficient bearing surface, will be used because the nut has to fit into the corresponding cavity in the socket attachment and both the nut and the socket attachment have to fit through the very tight access to the bolt or stud.

As will be apparent, depending on the exposed length of bolt or stud 24, the length or depth of threaded bore 30 will have to be at least long enough to accommodate the exposed length of bolt or stud 24 so as to allow end 28b to be snugged and torqued down onto the surface 32, for example a valve cover, being secured onto the exposed bolt or stud. Assuming that socket wrench 10 is conventional in the sense that stub drive shaft 14 is a conventional quarter inch, three eighths inch, half inch, three-quarter inch, or one inch diameter drive, then shaft receiving socket 16 may be sized accordingly to snugly accommodate the corresponding stub drive shaft diameter. As is usual, with small diameter fasteners 28, it may be that socket 16 may only be sized to accommodate a quarter inch drive shaft. Of course, the larger the diameter of fastener 28, the larger the diameter of drive shaft 14 or head 26a which may be accommodated in socket 16. The use of an increasingly sized array of fasteners 28 will provide a corresponding array of increasingly sized threaded bores 30 so that a set of fasteners 28 may provide for a full range of expected sizes of threaded fasteners. Of course, threads 30a may be of various pitch or size to accommodate the various threads found on the male fasteners, depending on the application.

In order to keep dirt, dust or for example liquids from intruding into threaded bore 30 via socket 16, a cap 34 may be provided which snugly and removably mounts into socket 16 by means of square-headed male mounting member 34a. Alternatively, incursion of dirt or liquid or the like into threaded bore 30 may be prevented by the forming of fastener 28 so as to include a rigid membrane 36 which extends completely over, and forms the base of, shaft receiving socket 16 to thereby separate socket 16 and bore as completely separated cavities. Cap 34 may be decorative and may include logos or trademarks having a commercial appeal or may provide for a capped chrome finish on a fastener 28, which may also have a chromed finish, so as to provide a decorative finished appearance especially where the use of conventional nuts would be unsightly because of the protrusion of the stud therethrough for example in engine compartments of vehicles used for showing.

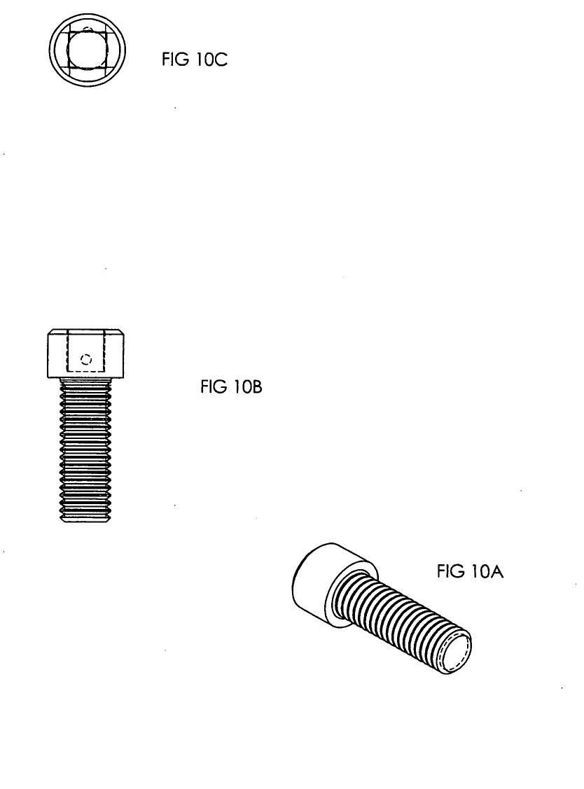

Depicted in FIGS. 10a-10c is a corresponding male fastener which may be used in applications where a bolt is required to be mounted into a threaded receptacle which itself is located in a very difficult to reach spot so that, again, the fastener may be positively locked onto the distal end of for example an extension 26 and remotely manipulated using a conventional socket wrench 10 to thereby drive the male fastener into threaded engagement in the threaded female cavity.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A ratchet mounting close-fit fastener comprising:
a rigid fastener body having opposite first and second ends, and a substantially smoothly curved outer surface extending from said first end to said second end,
said first end having a socket drive receiving cavity formed therein for receiving a male socket drive shaft into snug mating engagement along a longitudinal axis of said body, releasable locking means cooperating between said cavity and the drive shaft so as to releasably lock said fastener onto the drive shaft,
said second end formed to include a threaded portion wherein said threaded portion is symmetric about said longitudinal axis for threaded mating engagement of said threaded portion with a corresponding matingly-threaded second fastener and wherein said cavity and said threaded portion are oppositely disposed for said mounting of said drive shaft to said cavity and said mounting of the second fastener to said threaded portion from opposed facing opposite directions.

2. The fastener of claim 1 wherein said outer surface does not include shoulders formed along said outer surface parallel with said longitudinal axis.

3. The fastener of claim 1 wherein said threaded portion is a female threaded bore and said cavity and said bore are separated by a sealed barrier between said cavity and said bore.

4. The fastener of claim 1 wherein said threaded portion is a female threaded bore.

5. The fastener of claim 1 further comprising a de-mountable cap releasably mountable onto said first end so as to seal an opening into said cavity.

6. The fastener of claim 1 wherein said threaded portion is a threaded male end having a threaded surface around the exterior surface of said male end.

7. The fastener of claim 1 wherein said outer surface is substantially cylindrical.

8. The fastener of claim 4 wherein said bore is cylindrical and said bore has a diameter measured orthogonal to said axis and a length along said longitudinal axis and wherein said length is at least equal to said diameter.

9. The fastener of claim 4 wherein said second end terminates in a planar surface substantially orthogonal to said longitudinal axis.

10. The fastener of claim 9 wherein said planar surface is an annular surface extending circumferentially around an opening into said bore so as to provide a bearing surface around said opening.

11. The fastener of claim 10 wherein said outer surface is substantially cylindrical.

12. The fastener of claim 10 wherein said cavity and said bore are separated by a sealed barrier.

13. The fastener of claim 12 wherein said barrier is a membrane.

14. The fastener of claim 13 wherein said membrane is rigid.

15. A ratchet mounting close-fit fastener system comprising:
first and second fastener elements, each said element having a rigid body having opposite first and second ends, and a substantially smoothly curved outer surface extending from said first end to said second end,
said first end having a socket drive receiving cavity formed therein for receiving a male socket drive shaft into snug mating engagement along a longitudinal axis of said body, releasable locking means cooperating between said cavity and the drive shaft so as to releasably lock said fastener onto the drive shaft,
said second end formed to include a threaded portion wherein said threaded portion is symmetric about said longitudinal axis for threaded mating engagement of said threaded portion of each said elements with each other, and wherein said cavity and said threaded portion are oppositely disposed for said mounting of a drive shaft to said cavity and said mounting of said elements to each other from opposed facing opposite directions.

16. The fastener system of claim 15 wherein said outer surface does not include shoulder formed along said outer surface parallel with said longitudinal axis.

17. The fastener system of claim 15 wherein said threaded portion of said first fastener element is a female bore threaded end and wherein said threaded portion of said second fastener element is a male threaded end sized to threadably mate into said female bore threaded end.

18. The fastener system of claim 17 wherein said outer surface of said elements is substantially cylindrical.

19. The fastener system of claim 18 wherein said bore is cylindrical and said bore has a diameter measured orthogonal to said axis and a length along said longitudinal axis and wherein said length is at least equal to said diameter.

20. The fastener system of claim 19 wherein said second end of said first fastener element terminates in a planar surface substantially orthogonal to said longitudinal axis.

21. The fastener system of claim 20 wherein said planar surface is an annular surface extending circumferentially around an opening into said bore so as to provide a bearing surface around said opening.

22. The fastener system of claim 15 wherein said cavity and said bore of said first fastener element are separated by a sealed barrier.
